(19) United States
(12) Patent Application Publication
(10) Pub. No.: US 2010/0242927 A1
(43) Pub. Date: Sep. 30, 2010

(54) SEAL RING FOR EXHAUST GAS RECIRCULATION SYSTEM

(75) Inventors: Torsten Recktenwald, Essen (DE); Tibor Moeller, Duesseldorf (DE)

Correspondence Address: LARSON NEWMAN & ABEL, LLP, 5914 WEST COURTYARD DRIVE, SUITE 200, AUSTIN, TX, 78730, US

(73) Assignee: SAINT-GOBAIN PERFORMANCE PLASTICS PAMPUS GMBH, Willich (DE)

(21) Appl. No.: 12/748,564

(22) Filed: Mar. 29, 2010

Related U.S. Application Data
(60) Provisional application No. 61/164,691, filed on Mar. 30, 2009.

(51) Int. Cl. F02M 25/07; F16J 15/32

(52) U.S. Cl. 123/568.11; 277/549

(57) ABSTRACT

An ring seal assembly includes a ring and a seal located within the ring. The ring has a proximal end including a major lip, a distal end including a minor lip, and a seal contacting region between the major lip and the minor lip. Additionally, the ring including an inner surface defining a central bore. Within the seal contacting region, the central bore has a radius that decreases along a direction extending from the minor lip to the major lip. The seal has a ring contacting outer portion and a shaft contacting inner portion. The ring contacting outer portion is shaped to be complementary to the inner surface of the seal contacting region of the ring. The shaft contacting inner portion is configured to contact a shaft placed within the central bore of the ring.

### CROSS-REFERENCE TO RELATED APPLICATION(S)

The present application claims priority from U.S. Provisional Patent Application No. 61/164,691, filed Mar. 30, 2009, entitled “SEAL RING FOR EXHAUST GAS RECIRCULATION SYSTEM,” naming inventors Torsten Recktenwald and Tibor Moeller, which application is incorporated by reference herein in its entirety.

### FIELD OF THE DISCLOSURE

The present disclosure relates generally to seal rings. More specifically, the present disclosure relates to a seal ring for an exhaust gas recirculation (EGR) system.

### BACKGROUND

In modern internal combustion engines, the air flow in the intake system and/or the exhaust gas flow in the exhaust gas system are controlled or regulated by electronically controlled valve devices. The appropriate valve devices are, for example, a throttle valve, and exhaust gas recirculation (EGR) valve, a bypass valve of a supercharger, etc. Such valve devices normally include a channel through which the air stream and the exhaust gas stream flow, a rotatable or displaceable valve element which controls the flow quantity as a function of its setting, an electrical actuating device, for instance a DC motor, a mechanical connection between the valve element and the actuating device, a sensor that records the current setting of the valve element, and a control and regulation device that ascertains the actuating signal that is applied to the actuating device in order to obtain a desired position of the valve element.

EGR valves are a major part of anti-pollution devices on the internal combustion engines of present day vehicles. EGR valves are attached to the exhaust manifold where the crossover pipe leads to the intake manifold. At that point, the valve is inserted into the exhaust manifold through a pre-existing hole to regulate the amount of exhaust entering the intake manifold. This cools the peak combustion temperature, provides a better burn of the gas, and reduces NOₓ emissions.

### SUMMARY

In an exemplary embodiment, a ring seal assembly can include a ring and a seal. The ring can have a proximal end including a major lip and a distal end including a minor lip. Additionally, the ring can have a seal contacting region between the major lip and the minor lip. Further, the ring can have an inner surface defining a central bore. Within the seal contacting region, the central bore can have a radius that decreases along a direction extending from the minor lip to the major lip. The seal can have a ring contacting outer portion and a shaft contacting inner portion. The ring contacting outer portion can be shaped to be complementary to the inner surface of the seal contacting region of the ring and a shaft contacting inner portion can be configured to contact a shaft placed within the central bore of the ring.

In another exemplary embodiment, an EGR valve system can include an actuator, a shaft coupled to the actuator, and a valve disk coupled to the shaft. The valve disk can be configured to regulate an amount of exhaust gas being passed to an intake manifold. Additionally, the EGR valve system can include a ring seal assembly placed on the shaft to substantially limit the amount of exhaust gas that contacts the actuator. The ring seal assembly can include a ring and a seal. The ring can have a proximal end including a major lip and a distal end including a minor lip. Additionally, the ring can have a seal contacting region between the major lip and the minor lip. Further, the ring can have an inner surface defining a central bore. Within the seal contacting region, the central bore can have a radius that decreases along a direction extending from the minor lip to the major lip. The seal can have a ring contacting outer portion and a shaft contacting inner portion. The ring contacting outer portion can be shaped to be complementary to the inner surface of the seal contacting region of the ring and a shaft contacting inner portion can be configured to contact a shaft placed within the central bore of the ring.

In a further exemplary embodiment, a method of operating an internal combustion engine can include receiving an exhaust gas from an internal combustion engine, mixing a portion of the exhaust gas with air to form an intake gas mixture, and providing the intake gas to the internal combustion engine. Additionally, the method can include controlling the ratio of the exhaust gas to air by activating an actuator, and protecting the actuator from the exhaust gas. In order to control the ratio of exhaust gas to air, the actuator can move a shaft attached to a valve disk in order to alter the amount of exhaust gas added to the intake gas mixture. The actuator can be protected from the exhaust gas by using a ring seal assembly located on the shaft between the valve disk and the actuator. The ring seal assembly can include a ring and a seal. The ring can have a proximal end including a major lip and a distal end including a minor lip. Additionally, the ring can have a seal contacting region between the major lip and the minor lip. Further, the ring can have an inner surface defining a central bore. Within the seal contacting region, the central bore can have a radius that decreases along a direction extending from the minor lip to the major lip. The seal can have a ring contacting outer portion and a shaft contacting inner portion. The ring contacting outer portion can be shaped to be complementary to the inner surface of the seal contacting region of the ring and a shaft contacting inner portion can be configured to contact a shaft placed within the central bore of the ring.

### BRIEF DESCRIPTION OF THE DRAWINGS

The present disclosure may be better understood, and its numerous features and advantages made apparent to those skilled in the art by referencing the accompanying drawings.

FIG. 1 is a diagram illustrating an embodiment of seal ring.

FIG. 2 is a diagram illustrating an sealed shaft assembly.

FIG. 3 is a diagram illustrating an embodiment of an exhaust gas recirculation valve.

FIG. 4 is a diagram illustrating an alternate embodiment of seal ring.

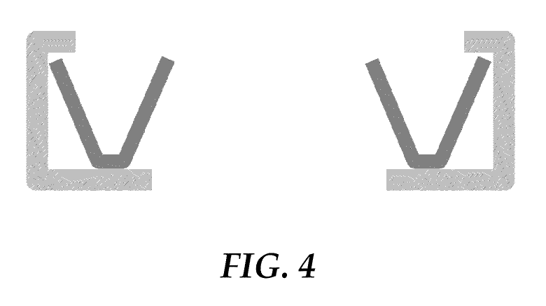

The use of the same reference symbols in different drawings indicates similar or identical items.

### DETAILED DESCRIPTION

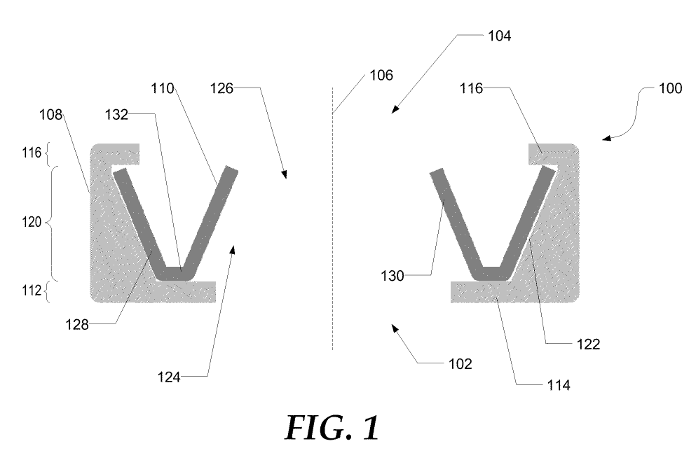

FIG. 1 illustrates an exemplary embodiment of a ring seal 100. The ring seal 100 can include a proximal end 102, a distal end 104, and a central axis 106. The ring seal can include a ring 108 and a seal 110. The ring 108 can be divided into three regions located along the central axis 106. At the proximal end 102, a proximal region 112 can include a major lip 114. At the distal end 104, a distal region 116 can include a minor lip 118. Between the proximal region 112 and the distal region 116, the ring can include a seal contacting region 120. The ring 108 can have an inner surface 122 defining a central bore 124. Within the seal contacting region 120, the inner surface 122 can be angled to cause the radius of the central bore 124 to decrease along a direction from the minor lip 116 to the major lip 114. In an embodiment, the radius can decrease linearly with distance, resulting in a cross section having a flat inner surface. In an alternative embodiment, the radius can decrease nonlinearly with the distance, resulting in a cross section having a curved inner surface, such as a convex or a concave cross sectional inner surface. Additionally, the inner surface of the seal contacting region 120 can have a overall slope of between about 1.0 to about 5.0, such as between about 2.0 to about 4.0. As used herein, the overall slope is defined as the ratio of the length of the seal contacting region 120 to the overall change in the radius of the central bore 124 over the length of the seal contacting region 124.

The seal 110 can be an annular seal having a passage 126 formed through the center. The seal include an outer portion 128 and an inner portion 130. The outer portion 128 can contact the inner surface 122 of the ring 108 within the seal contacting region 120. The inner portion 130 can be located adjacent to the passage 126 and can be substantially free of contact with the ring 108. In an embodiment, the seal 110 can have a flattened V-shaped cross section as shown. That is, the seal 110 can have a flattened joining region 132, rather than a pointed vertex, where the inner portion 130 and the outer portion 128 meet. Alternatively, the seal 110 can have a U-shaped cross section having a curved joining region or a V-shaped cross section having a pointed vertex at the joining region.

When assembled, the seal 110 can be generally contained within the seal contacting region 120 and held in place between the major lip 114 and the minor lip 118. Further, the inner portion 130 of the seal can contact the inner surface of the seal contacting region 120 of the ring along substantially the entire length of the seal contacting region 120, thereby preventing the formation of a void space between the seal 110 and the ring 108.

In an embodiment, the ring 108 can be formed of a substantially rigid material, such as brass, steel, and certain plastics. The seal 110 can be formed of a semi-rigid or flexible material, such as certain natural and synthetic polymers. For example, the seal can include polytetrafluoroethylene (PTFE), rubber, latex, polyethylene, polyamide, and the like. Further, the seal can include fillers and additives known to modify certain physical properties, such as rigidity, wear resistance, thermal stability, and chemical resistance, of the polymer.

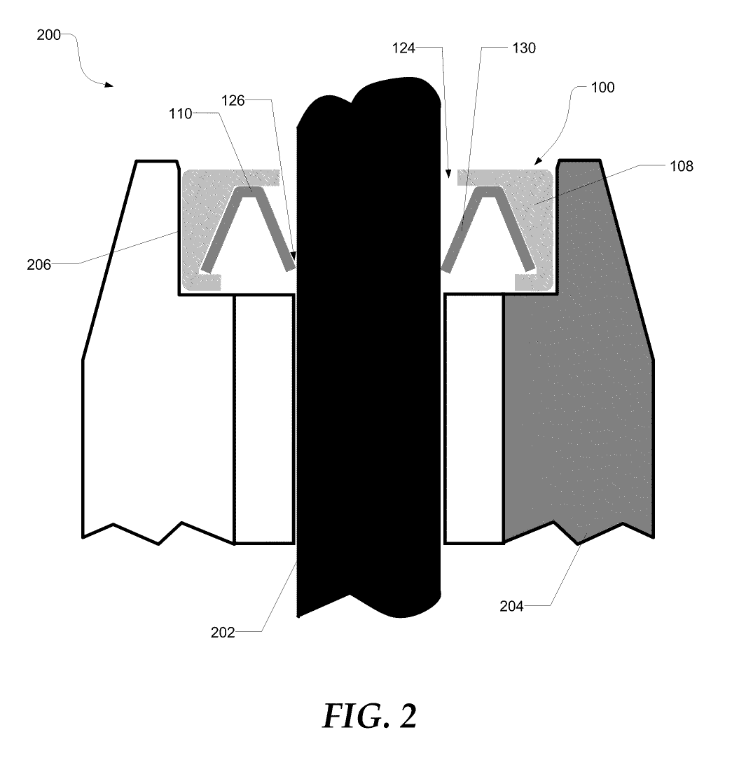

FIG. 2 illustrates an exemplary embodiment sealed shaft assembly 200. A shaft 202 can be held within a shaft guide 204. Ring seal 100 can be placed within ring seal slot 206 formed on the shaft guide 204. The shaft 202 can be place through the central bore 124 of the ring 108 and through the passage 126 of the seal 110. Generally, the shaft can have minimal contact with the inner surface 122 of the ring 108 and maintain contact with the inner portion 130 of the seal 110.

In an embodiment, the ring seal 100 and sealed shaft assembly 200 can be used in an EGR valve, as described in more detail below. Alternatively, the ring seal 100 can be used in other applications, where a translating or rotating shaft passes through a barrier or wall and contamination needs to be substantially prevented from passing through the barrier or wall. Contamination can include liquids, gasses, or particulate material, such as dust. Additionally, the ring seal 100 can be used in applications typically known to use spring biased seals. In an embodiment, the ring seal 100 can have an average leakage rate of less than about 4.0 ml/min, such as less than about 3.0 ml/min, less than about 2.0 ml/min, even less than about 1.0 ml/min.

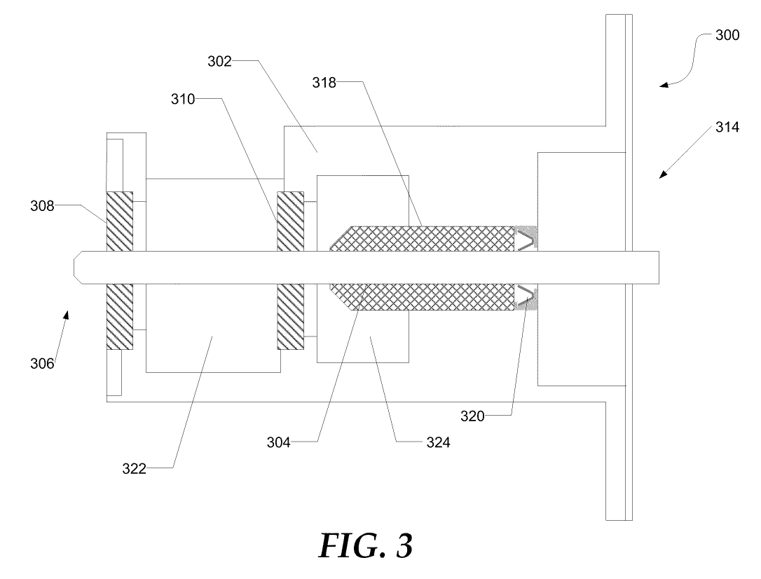

FIG. 3 illustrates an exemplary embodiment of an ERG valve 300. The EGR valve 300 can include a valve body 302 and a valve stem 304 through the valve body 302. At a distal end 306 of the EGR valve 300, plate seals 308 and 310 can be attached to the valve stem 304. The EGR valve 300 can include a proximal end 314 to which an actuator (not shown) can be attached to translate the valve stem 304. Additionally, a stem guide 318 can secure the valve stem 304 within the valve body 302. Further, a ring seal 320 can be positioned around the valve stem 304 proximal to the stem guide 318. The ring seal 320 can provide a seal between the proximal end 314 and the distal end 306 of the EGR valve to substantially limit the passage of gasses between the distal end 306 and the proximal end 314.

The valve body 302 can include an exhaust gas inlet 322 and an exhaust gas outlet 324. The exhaust gas inlet 322 can be in fluid communication with an exhaust manifold of an internal combustion engine and the exhaust gas outlet 324 can be in fluid communication with an intake manifold of the internal combustion engine. In a closed position, the plate seals 308 and 310 can separate the exhaust gas inlet 322 from the exhaust gas outlet 324 and can substantially prevent exhaust gases passing from the exhaust manifold to the intake manifold. In an open position, the valve stem 304 can be translated towards the proximal end 314 of the EGR valve 300 causing the plate seals 308 and 310 to open and allow passage of exhaust gas from the exhaust gas inlet 322 to the exhaust gas outlet 324. Accordingly, the exhaust gas from the internal combustion engine can be recirculated from the exhaust manifold to the intake manifold.

During operation, an actuator (not shown), such as an electric motor, a solenoid, or a pneumatic actuator, can move the EGR valve 300 between the open and closed positions, thereby controlling the amount of exhaust gas recirculated from the exhaust manifold to the intake manifold. The recirculated exhaust gas can be mixed with air to form an intake gas prior to reaching the internal combustion engine. The recirculated exhaust gas can reduce the amount of oxygen in the intake gas, thereby cooling the operating temperature of the internal combustion engine and can reduce NOₓ emissions. Additionally, the ring seal can substantially reduce the amount of exhaust gasses that contact the actuator and increase the lifetime of the actuator and the EGR valve 300, thereby reducing maintenance costs.

### EXAMPLES

The samples are assembled within an EGR valve test rig. Average leakage rates are determined by applying a pressure of 1 bar to the exhaust gas inlet and exhaust gas outlet and measuring the flow across the ring seal using a flow meter. The results are shown in Table 1.

Comparative Sample 1 includes a ring having a substantially constant radius within the seal contacting region, as shown in FIG. 3. Comparative Sample 1 is a serial production run of 100 ring seals.

Sample 1 includes a ring having a linearly decreasing radius within the seal contacting region along a distance from the minor lip to the major lip, as shown in FIG. 1. Sample 1 is a sample production run of 50 ring seals.

Sample 2 is the same as Sample 1, except sample 2 is a serial production run of 100 ring seals.

TABLE 1

| | Mean | Std Dev | Number |
|---|---|---|---|
| | (ml/min) | (ml/min) | Tested |
| Comparative Sample 1 | 22.44 | 78 | 100 |
| Sample 1 | 0.92 | 0.8 | 50 |
| Sample 2 | 3.23 | 2.1 | 100 |

1. A ring seal assembly comprising:
a ring having a proximal end including a major lip, a distal end including a minor lip, and a seal contacting region between the major lip and the minor lip, the ring including an inner surface defining a central bore, within the seal contacting region the central bore having a radius that decreases along a direction extending from the minor lip to the major lip; and
a seal located within the ring having a ring contacting outer portion shaped to be complementary to the inner surface of the seal contacting region of the ring and a shaft contacting inner portion configured to contact a shaft placed within the central bore of the ring.

2. The ring seal assembly of claim 1, wherein the ring contacting outer portion is shaped to be complementary to the inner surface of the seal along the entire axial length of the interface between the seal and the ring such that there is no void between the ring and the seal.

3. The ring seal assembly of claim 1, wherein the seal has a U-shaped cross section, a V-shaped cross section, a flattened V-shaped cross section, or any combination thereof.

4. The ring seal assembly of claim 1, wherein the seal includes a polytetrafluoroethylene, rubber, latex, polyethylene, polyamide, acetal resin, or any combination thereof.

5. The ring seal assembly of claim 4, wherein the seal further includes a filler.

6. The ring seal assembly of claim 1, wherein the ring includes brass, steel, plastic, or any combination thereof.

7. The ring seal assembly of claim 1, wherein the inner surface of the ring within the seal contacting region is substantially linear.

8. The ring seal assembly of claim 1, wherein the inner surface of the ring within the seal contacting region is curved.

9. An exhaust gas recirculation valve system comprising
a actuator;
a shaft coupled to the actuator;
a valve disk coupled to the shaft, the valve disk configured to regulate the amount of exhaust gas being passed to an intake manifold; and
a ring seal assembly placed on the shaft, the ring seal including
a ring having a proximal end including a major lip, a distal end including a minor lip, and a seal contacting region between the major lip and the minor lip, the ring including an inner surface defining a central bore, within the seal contacting region the central bore a radius that decreases along a direction extending from the minor lip to the major lip; and
a seal located within the ring having a ring contacting outer portion shaped to be complementary to the inner surface of the seal contacting region of the ring and a shaft contacting inner portion configured to contact a shaft placed within the central bore of the ring,
wherein the ring seal assembly acts to substantially prevent the exhaust gas from contacting the actuator.

10. The exhaust gas recirculation valve system of claim 9, wherein the ring contacting outer portion is shaped to be complementary to the inner surface of the seal along the entire axial length of the interface between the seal and the ring such that there is no void between the ring and the seal.

11. The exhaust gas recirculation valve system of claim 9, wherein the actuator is an electric motor or a solenoid.

12. The exhaust gas recirculation valve system of claim 9, wherein the seal has a U-shaped cross section, a V-shaped cross section, a flattened V-shaped cross section, or any combination thereof.

13.-15. (canceled)

16. The exhaust gas recirculation valve system of claim 9, wherein the inner surface of the ring within the seal contacting region is substantially linear.

17. The exhaust gas recirculation valve system of claim 9, wherein the inner surface of the ring within the seal contacting region is curved.

18. A method of operating an internal combustion engine, comprising:
receiving an exhaust gas from an internal combustion engine,
mixing a portion of the exhaust gas with air to form an intake gas mixture;
controlling the ratio of the exhaust gas to air by activating an actuator to move shaft attached to a valve disk in order to alter the amount of exhaust gas added to the intake gas mixture;
protecting the actuator from the exhaust gas using a ring seal assembly located on the shaft between the valve disk and the actuator, the ring seal assembly including:
a ring having a proximal end including a major lip, a distal end including a minor lip, and a seal contacting region between the major lip and the minor lip, the ring including an inner surface defining a central bore, within the seal contacting region the central bore having a radius that decreases along a direction extending from the minor lip to the major lip; and
a seal located within the ring having a ring contacting outer portion shaped to be complementary to the inner surface of the seal contacting region of the ring and a shaft contacting inner portion configured to contact a shaft placed within the central bore of the ring; and
providing the intake gas to the internal combustion engine.

19. The method of claim 18, wherein the ring contacting outer portion is shaped to be complementary to the inner surface of the seal along the entire axial length of the interface between the seal and the ring such that there is no void between the ring and the seal.

20. The method of claim 18, wherein the actuator is an electric motor or a solenoid.

21. The method of claim 18, wherein the seal has a U-shaped cross section, a V-shaped cross section, a flattened V-shaped cross section, or any combination thereof.

22.-24. (canceled)

25. The method of claim 18, wherein the inner surface of the ring within the seal contacting region is substantially linear.

26. The method of claim 18, wherein the inner surface of the ring within the seal contacting region is curved.
